(19) United States
(12) Patent Application Publication
(10) Pub. No.: US 2023/0376645 A1
(43) Pub. Date: Nov. 23, 2023

(54) Faster Coverage Convergence with Automatic Test Parameter Tuning in Constrained Random Verification

(71) Applicant: Google LLC, Mountain View, CA (US)

(72) Inventors: Hamid Shojaei, San Jose, CA (US); Qijing Huang, Berkeley, CA (US); Chian-min Richard Ho, Palo Alto, CA (US); Satrajit Chatterjee, Palo Alto, CA (US); Shobha Vasudevan, Palo Alto, CA (US); Azade Nazi, San Jose, CA (US); Frederick Dennis Zyda, Redwood City, CA (US)

(73) Assignee: Google LLC, Mountain View, CA (US)

(21) Appl. No.: 18/248,458

(22) PCT Filed: Nov. 5, 2021
(86) PCT No.: PCT/US2021/058302

§ 371 Date: Apr. 10, 2023

Related U.S. Application Data
(60) Provisional application No. 63/111,995, filed on Nov. 10, 2020.

(51) Int. Cl. G06F 30/17

(52) U.S. Cl. CPC G06F 30/17

(57) ABSTRACT

This document discloses systems and methods for implementing automatic test parameter tuning in constrained random verification. In aspects, a method receives a first set of parameters for testing a design under test, performs a first regression (e.g., an overnight regression test) on a design under test using the first set of parameters, and analyzes the results of the first regression including determining a coverage percentage. The method then generates an optimized set of parameters based on the analysis of the results of the first regression and performs an additional regression on the design under test using the optimized set of parameters. In aspects, the method is repeated using the optimized set of parameters until a coverage percentage is reached, or in some implementations, full coverage may be reached. Some implementations of the method utilize black-box optimization through use of a Bayesian optimization algorithm.

### BACKGROUND

Constrained random verification (CRV) is a de facto standard in industrial-design verification. Central to this process is a design of a testbench that applies pseudorandom stimulus to a design under test (DUT) downstream. The testbench typically includes parameterized tests that are manually crafted for verifying functionality. Each parameter acts as a high-level knob to control stimulus generation, and the testbench then generates a family of related stimuli based on these configurable parameters (and a pseudorandom generator controlled by a seed).

Examples of such test parameterizations are shown in FIGS. 1A and 1B, which specifically illustrate example test parameterizations for a processor core (e.g., Ibex), a production-quality open-source 32-bit CPU (central processing unit) core that implements RISC-V (reduced instruction set computer). FIG. 1A illustrates test parameterizations 100 related to exception handling, and FIG. 1B illustrates test parameterizations 110 related to MMU (memory management unit) stress tests. The example test parameterizations of FIGS. 1A and 1B have 15 numerical and 16 Boolean parameters. If a test system explores eight values for each numerical parameter, the search space is:

2¹⁶×(2³)¹⁵=2⁶¹

This represents a very large search space that may be difficult for verification engineers to fully explore.

Verification engineers typically rely on increased coverage over time simply through variations in the random seed. With increasing design complexity, the number of parameters increases, making it harder for a human to effectively reason about the higher dimensional parameter space. For example, human engineers may miss trends among parameter values or draw incorrect conclusions, resulting in sub-optimal coverage and runtime for tests. These problems add to the cost of verification and coverage closure, which is a costly, inefficient process that may take multiple person-years to verify industrial designs.

### SUMMARY

This document discloses systems and methods for implementing automatic test parameter tuning in constrained random verification. In aspects, a method receives a first set of parameters for testing a design under test, performs a first regression on a design under test using the first set of parameters, and analyzes the results of the first regression including determining a coverage percentage for the first regression. The method then generates an optimized set of parameters based on the analysis of the results of the first regression and performs a subsequent regression on the design under test using the optimized set of parameters. The method may be repeated using the iteratively optimized set of parameters until a coverage percentage is reached (e.g., based on a threshold), or in some implementations, full coverage is reached. Some implementations of the method may utilize black-box optimization through use of a Bayesian optimization algorithm In aspects, black-box optimization is an optimization method that optimizes a function without the function being visible to the optimizer. Specifically, the function, or the function outputs may be analyzed, but the function itself is unknown to the optimizer. In some implementations, the method is implemented as computer-readable instructions stored in computer-readable storage media (CRM) and executed by a processor. For example, the black-box optimization may be implemented in a hardware description language (HDL). Alternatively, the method may be implemented by a system containing one or more processors that execute computer-readable instructions of a CRM to implement the described aspects.

This Summary is provided to introduce simplified concepts for implementing automatic test parameter tuning in constrained random verification. The simplified concepts are further described below in the Detailed Description. This Summary is not intended to identify essential features of the claimed subject matter, nor is it intended for use in determining the scope of the claimed subject matter.

### BRIEF DESCRIPTION OF THE DRAWINGS

The details of one or more aspects of the described systems and methods are described below. The use of the same reference numbers in different instances in the description and the figures indicate similar elements:

FIGS. 1A and 1B illustrate example test parameterizations for an Ibex core;

FIG. 2 illustrates an example of a Smart Regression Planner (SRP) framework;

FIG. 3 illustrates a simplified example of Bayesian optimization for a single parameter;

FIG. 4 illustrates experimental results of point-in-time coverage C_{PIT} over 100 regression iterations;

FIG. 5 illustrates experimental statistics related to point-in-time coverage C_{PIT};

FIG. 6 illustrates experimental results of accumulated coverage C_{ACC} over 100 regression iterations;

FIG. 7 illustrates experimental statistics related to accumulated coverage C_{ACC},

FIG. 8 illustrates experimental results of point-in-time coverage C_{PIT} over 100 regression iterations in addition to a baseline;

FIG. 9 illustrates experimental results of accumulated coverage C_{ACC} over 100 regression iterations in addition to a baseline;

FIG. 10 illustrates experimental results of a ratio of point-in-time coverage C_{PIT} over runtime for Ibex with multi-objective optimization (MO);

FIG. 11 illustrates experimental statistics related to point-in-time coverage C_{PIT} and runtime for Ibex with multi-objective optimization;

FIG. 12 illustrates experimental results of test parameters suggested by GP-Bandit for 100 iterations;

FIG. 13 illustrates an example Smart Regression Planner test with learned parameters and corresponding manually created baseline test with lower coverage C_{PIT};

FIG. 14 illustrates experimental results of a point-in-time coverage C_{PIT} over 200 regression iterations;

FIG. 15 illustrates experimental statistics related to point-in-time coverage C_{PIT} for experiments with the same number of instructions;

FIG. 16 illustrates experimental results of accumulated coverage C_{ACC} over 100 regression iterations for experiments with the same number of instructions;

FIG. 17 illustrates experimental statistics related to point-in-time coverage C_{PIT} with a fixed seed;

FIG. 18 illustrates experimental statistics related to point-in-time coverage C_{PIT} comparison of Fixed Seed+Gaussian Process Bandits (GP-Bandit) versus Random Seed+baseline;

FIG. 19 illustrates an example method of automatic test parameter tuning; and

FIG. 20 illustrates various examples of a computing system in which automatic test parameter tuning in constrained random verification can be implemented.

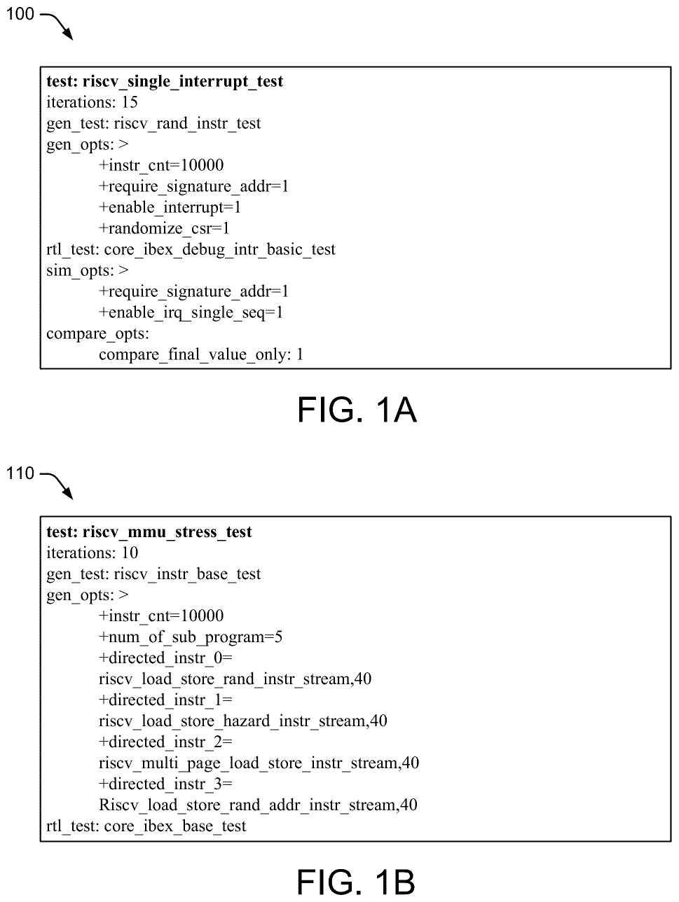

### DETAILED DESCRIPTION

The systems and methods for automatic test parameter tuning in constrained random verification described herein may provide an improved approach to automatically configuring test parameters that leads toward increased test coverage. Aspects of the described systems and methods are useful in testing various hardware devices, such as central processing units (CPUs), machine learning processors, memory, cache controllers, and other processing devices. Described systems and methods are also useful in testing different types of algorithms and software applications.

Aspects of a Smart Regression Planner (SRP) framework discussed herein may automatically configure multiple tunable test parameters to better explore an input space and converge quickly towards a desired verification coverage. The SRP framework may formulate test parameter configuration as a black-box optimization problem and solve it using Bayesian optimization or other (non-Bayesian) optimization methods with analyzed coverage results fed back from regression iterations. Particular examples discussed herein refer to regression iterations or “nightly regressions,” which refers to running a testing process on a nightly basis. An iteration or nightly regression is an example of a continuous integration (CI) with automated testing. In alternate implementations of the systems and methods discussed herein, the testing process may be repeated at any interval and is not limited to nightly testing.

As discussed herein, random perturbation of human-defined test parameters may provide an improved functional coverage (and coverage in general) of the testing systems and methods. For example, in a RISC-V verification platform, the described systems and methods for automatic test parameter tuning in constrained random verification may result in approximately 60% functional coverage difference between the best and worst configurations. The fine-grained parameter tuning described herein provides a unique opportunity for increasing functional and code coverage with no additional effort from the verification engineers beyond setting up the system.

### Smart Regression Planner (SRP)

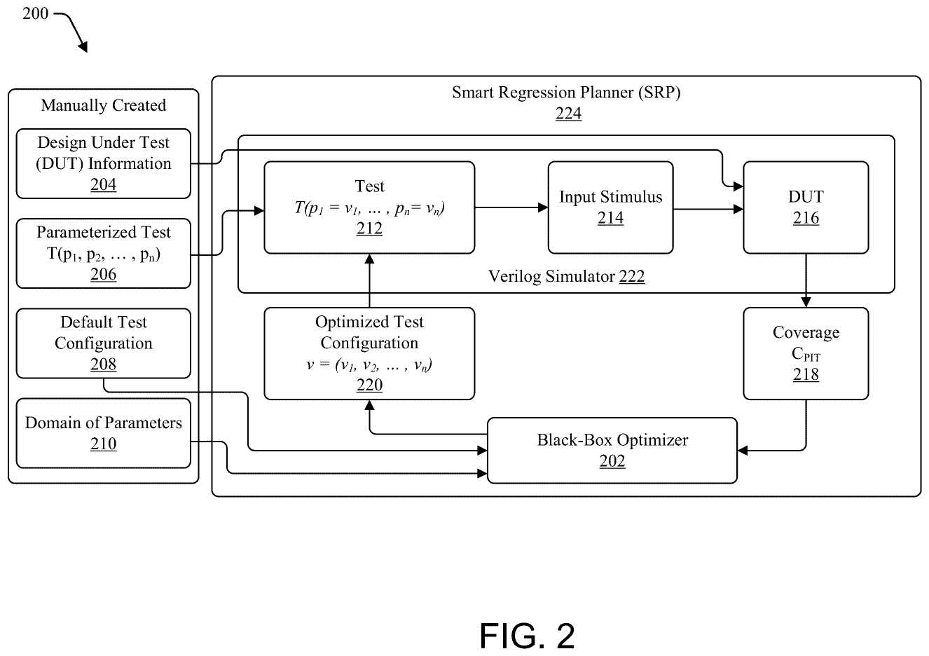

FIG. 2 illustrates an example of a Smart Regression Planner (SRP) framework 200, which supports an approach to high-level test parameter configuration with the goal of quick coverage convergence. With SRP framework 200, the systems and methods described herein may approach the problem at the parameterized testbench level of the verification flow. Traditional research on input stimulus generation is at the Boolean input level, instruction (or transaction) level, or constraint level. Searching the space of input stimulus directly often suffers from combinatorial explosion, making solutions prohibitively expensive. In contrast, SRP framework 200 works at a higher level of abstraction that naturally has fewer configurable inputs (<100), yet still directly impacts verification coverage.

SRP framework 200 may formulate test parameter configuration as a black-box optimization problem, which is implemented by a black-box optimizer 202. The tractable input dimensions allow the application of powerful ML-based (machine learning-based) Bayesian optimization methods to test parameter configuration. Bayesian optimization is agnostic to structure and flexible enough to adapt to changes in an evolving design. In addition to Bayesian optimization, the described systems and methods may also employ a simple random search (random perturbation of parameters) as a comparative algorithm In alternate implementations, other algorithms based on an evolutionary search may be used instead of Bayesian optimization. While random search relies purely on exploration, Bayesian optimization exploits learning through feedback. In some aspects, the systems and methods also explore common use cases of: simultaneously minimizing runtime and maximizing coverage using multi-objective Bayesian optimization; and transfer learning, or the ability to transfer learned heuristics from one set of parameters to another through design evolution.

As shown in the example of FIG. 2, SRP framework 200 receives information related to a design under test (DUT), a parameterized test, a default test configuration, and a domain of parameters. In some aspects, the design under test is a chip or a portion of a chip (e.g., a block of a chip). In particular aspects, information related to at least one of the design under test, the parameterized test, the default test configuration, or the domain of parameters is provided by a verification engineer or other user. The activities shown in SRP framework 200 may be performed automatically without input from a verification engineer, as discussed herein.

For example, a Verilog simulator 222 can be used to simulate a test 212 on a DUT 216. The test 212 and the DUT 216 are configured from a parameterized test 206 and DUT information 204 provided by the verification engineer. In aspects, the Verilog simulator 222 analyzes an iteration or nightly regression performed on the DUT 216 using an input stimulus 214 configured from the default test configuration 208 (set of parameters). The analyzed results of the first nightly regression contain a coverage 218 (point-in-time coverage) which may be input to the black-box optimizer 202 to determine an optimized test configuration 220 (set of parameters) from the domain of parameters 210, or input space, provided by the verification engineer. The optimized test configuration 220 may be used to perform a subsequent nightly regression, the results of which may be analyzed and again provided to the black-box optimizer 202. In some implementations the DUT 216 is a representation of a hardware system, for example, using a hardware description language, a very-high-speed integrated circuit HDL (VHDL), Verilog, SystemC, or so forth. In aspects, the DUT 216 can be represented as a logical representation of a hardware system of logical components for fabrication as an integrated circuit. As such, the SRP framework 200 can be used to validate hardware systems, such as silicon devices, processor cores, co-processors, or SoCs in whole or part. In aspects, the logical components of the hardware system may include a processor, a memory, an arithmetic unit, a data bus, a register, a logic gate array, a logic gate map, a configurable logic block, a look up table (LUT), input/output (I/O) logic, selection tree, sense amplifier, memory cell, or the like.

In some aspects, SRP framework 200 may be implemented in an industrial nightly regression flow. Through that implementation, it was found that the approach fits with minimal overhead into the flow. Furthermore, when regressions are run in the cloud, SRP framework 200 can opportunistically exploit idle capacity to increase exploration, leading to faster coverage improvement. Certain SRP framework 200 experiments were evaluated on two sets of designs: open-source (RISC-V, Ibex) as well as a larger industrial design MLChip. MLChip is an artificial intelligence accelerator implemented, for example, using an application-specific integrated circuit (ASIC) developed specifically for neural network machine learning. In some aspects, the accelerator is a Tensor Processing Unit (TPU). In particular aspects, the MLChip is the main block inside an artificial intelligence chip or system. As shown in detail below, the comprehensive set of experiments illustrated that test parameter optimization may consistently provide significant value to constrained random verification (CRV). In practical settings, where even a 1-2% coverage improvement is considered significant, use of the SRP framework 200 can result in substantial savings in human effort and time to closure.

In some aspects, the systems and methods measure coverage computed per iteration (point-in-time coverage) and the cumulative coverage over many iterations (accumulated coverage). During the SRP framework 200 experiments, the framework consistently achieved the maximal point-in-time coverage percentage (up to 9.52% higher than baseline) as well as maximal accumulated coverage percentage (up to 3.89% higher than baseline) across 100 nights on all designs. In some aspects, SRP framework 200 converges much faster than the human baseline on the last 5% and 0.5% accumulated coverage margins, showing its value in the difficult coverage closure phase. Over all designs, it takes the SRP framework 200 approach up to 81 fewer nights to reach the last 5% and at least 25 fewer nights to reach the last 0.5% of maximum attainable coverage. In comparison, the baseline did not reach the maximum coverage even in 100 nights for the MLChip. Additionally, the SRP framework 200 is able to detect more issues (6.86 failures per 1000 tests) than the human baseline (5.94 failures per 1000 tests) on the industrial design MLChip. This ability to detect more issues allows for faster debugging of the design under test. In aspects, multi-objective optimization using SRP framework 200 improves the runtime of simulations by 15% without experiencing a lack of coverage.

Although Bayesian optimization consistently outperforms random search and human baseline, even simple random search achieves much higher accumulated coverage than the human baseline. This approach could provide an easy advantage in many industrial settings. Based on the experiments performed using SRP framework 200, the various advantages were identified. In some implementations, SRP framework 200 provides a high-return, minimal-overhead opportunity for faster coverage convergence by automatically configuring test parameters in constrained random verification. In some experiments, it is illustrated that black-box Bayesian optimization is ideally suited to configure test parameters to achieve higher per-iteration coverage and higher total coverage. In aspects, the experiments demonstrate that, with comprehensive evaluation in an industrial setting, test parameter optimization provides a consistent increase in point-in-time, and fast convergence to accumulated coverage, which are highly valuable during coverage closure and bug detection. Further, the experiments demonstrate that even random perturbation of test parameter configurations may offer a simple yet powerful method of achieving higher accumulated coverage. Additionally, the experiments show value in Bayesian multi-objective optimization that trades off runtime for coverage and in transfer learning of heuristics between tests. In some implementations, the experiments address a problem space in verification that is practically valuable yet tractable enough to apply advanced machine learning and white-box optimization algorithms in the future.

In some aspects, the parameterized test 206 is defined as T(p1, p2, . . . pn) where pi is a test parameter that takes values in the given domain of parameters 210 (e.g., range) and test parameters can be numerical, categorical, or Boolean. In some instances, the parameterized test 206 includes hardware parameters (e.g., for a hardware design or processing system), for example, one or more of a bus width, data width, register depth, memory depth, voltage, clock frequency, timing variables, delays, etc. that can be used to test the hardware of a DUT 216. Given an assignment of values vi to each pi, simulation returns the (point-in-time) coverage 218 CPIT, which is a real number between 0 and 100%. A test configuration for T is the set of the test parameter values v=(v1, v2, . . . vn). The objective of regression planning may be to find a test configuration v* that maximizes CPIT. Since the function f, which maps a test configuration v to CPIT, does not have any obvious structure that may be exploited for optimization (such as convexity or smoothness), the systems and methods for implementing automatic test parameter tuning in constrained random verification consider black-box techniques.

Even though optimizing the point-in-time coverage 218 C_{PIT} may be the main objective of the problem, some aspects also measure the accumulated coverage C_{ACC} for a sequence of test configurations (also a real number between 0 and 100%) since it is a critical metric for coverage closure and sign-off.

As mentioned above, FIG. 2 shows SRP framework 200, which improves coverage closure in simulation. In the systems and methods described herein, a test may use a parameter configuration provided by the black-box optimizer 202 to generate input stimulus 214 for the DUT 216. The point-in-time coverage 218 C_{PIT} is computed by, for example, the Verilog simulator 222 that simulates the test 212 and the DUT 216, and this value is provided to black-box optimizer 202. Black-box optimizer 202 may then generates a new value for each test parameter pᵢ from its valid domain of parameters 210 that is fed back to the test 212 such that the test 212 and the DUT 216 are re-simulated with the new configuration (e.g., optimized test configuration 220). Black-box optimizer 202 may track coverage 218 results as a function of the test configuration. Over a series of simulation runs (e.g., iterations), black-box optimizer 202 (when using the Bayesian optimization algorithm) may improve coverage 218 and learn which combinations of test parameter values lead to maximum coverage. The process may continue until coverage closure is achieved (or a predetermined coverage closure threshold) or the maximum number of simulation runs allowed is reached.

In some aspects, for efficiency in the setup, the first configuration suggested by black-box optimizer 202 is set up to be the default test configuration 208 provided by the verification engineer (instead of a random configuration), though this can be changed in alternate implementations. Additionally, suggested test configurations of the black-box optimizer 202 may be automatically checked in to source control alongside the parameterized tests to track and diagnose regression failures with the existing tools.

The described systems and methods may not expose the random seed parameter to black-box optimizer 202 as a test parameter, which consequently sees a stochastic optimization problem. In some aspects, black-box optimizer 202 is optimized by formulating regression planning as an optimization problem. The goal is to find v*=argmaxᵥƒ(v), where v* is a test configuration that maximizes the C_{PIT}. Several classes of algorithms have been proposed from a simple RANDOM-SEARCH to more powerful techniques like Gaussian Process Bandits (GP-BANDIT) that are fundamentally Bayesian in nature. Both of these techniques are discussed herein.

RANDOM-SEARCH selects vₜ uniformly at random at time step t independent of the previous points selected. As such, the RANDOM-SEARCH technique may arbitrarily change the test configuration in every simulation.

In contrast, GP-BANDIT aims to sequentially optimize function ƒ by getting feedback from the environment. GP-BANDIT uses a Bayesian optimization technique, where it maintains a Gaussian prior GP(μ, Σ) over ƒ and updates it with samples drawn from ƒ to get a posterior from previous regressions that better approximates the objective. This algorithm may perform exploration and exploitation techniques to choose a test configuration. In an example, the strategy to pick a new configuration vₜ is:

vₜ=argmaxᵥ(μₜ₋₁(v)+βₜσₜ₋₁(v))

where βt is a constant that implicitly negotiates the exploration-exploitation tradeoff In the exploitation phase, GP-BANDIT may pick argmaxᵥ, μₜ₋₁(v), to maximize the expected reward based on the posterior from previous regressions and maximize the reward (CPIT 218). In the exploration, however, it acquires new information by choosing a new test configuration v, where ƒ s uncertain (σₜ₋ᵢ(v) is large).

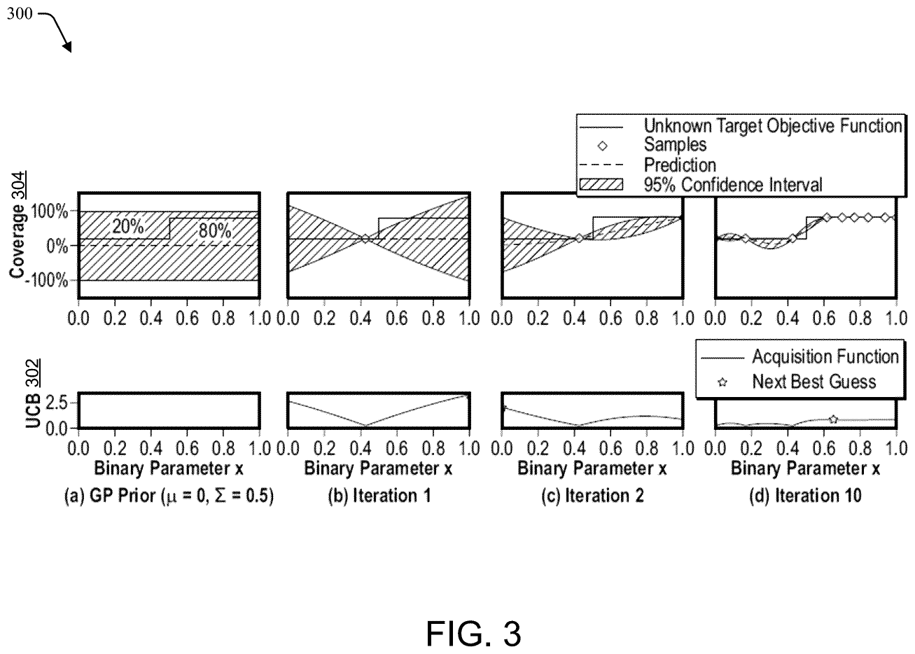

FIG. 3 illustrates a simplified example 300 of Bayesian optimization for a single parameter. In the example 300, a graphical representation of a black-box objective function predicting coverage 302 is illustrated above, while an acquisition function, for example upper confidence bound 304 (UCB 304), is shown below. The black-box objective function predicts the coverage 302 at a particular value of a parameter (e.g., parameter x). In an aspect, the black-box objective function utilizes a statistical model to predict the coverage 302 of a particular value. The acquisition function may leverage the predicted coverage and the uncertainty (represented by the 95% confidence interval) to determine an optimal value for parameter x. For example, the acquisition function may include a mean coverage percentage for a specific value of a parameter based on the analyzed results from the previous regressions using the previous parameter sets and an uncertainty coverage percentage for a specific value of a parameter based on an uncertainty of the statistical model using the analyzed results from the previous regressions using the previous parameter sets.

For example, a first simulation is run with parameter value 0.4. As a result, the predicted coverage 302 value is updated and the uncertainty at parameter x=0.4 is reduced. It should be noted that the uncertainty may increase as distance from a sampled value increases. The acquisition function determines the optimal value for parameter x based on the updated predicted coverage 302 and the updated uncertainty 0.4. As a result, a value of 1 is used for the next iteration. Again, the simulation is run with the given parameter value (e.g., x=1) and the predicted coverage 302 value and uncertainty is updated. The acquisition function is again used to determine an optimal value for parameter x to run the next simulation. In the example 300, this process repeated for 10 iterations, producing the final predicted coverage 302.

It should be noted that the example 300 is simplified for a single parameter. Additionally, though the acquisition function and statistical model are shown as specific models, any number of acquisition functions or statistical models may be appropriate. The acquisition function may include a negotiation constant that negotiates the tradeoff between exploitation of previous results (e.g., a smaller negotiation constant) and exploration of new parameter values (e.g., a larger negotiation constant). In an aspect, the black-box optimization described above utilizes a complex variation of the example 300 to perform parameter optimization for multiple parameters of the parameterized test. Results of the black-box optimization as described are further illustrated below.

### Test Results

The following experiments utilize the GP-BANDIT implementation discussed above with a βₜ value of 0.01. Further, the test results discussed herein are related to three different designs: RISC-V, Ibex, and MLChip. As mentioned above, RISC-V is a processor design adopting RISC-V ISA. RISC-V-DV is used to verify the design, and it reports functional coverage. Ibex is a 32-bit RISC-V CPU core. Code coverage is reported on Ibex. MLChip is the main block inside an artificial intelligence chip or system. In some aspects, it may provide a proprietary deep-learning accelerator featuring systolic arrays of multiply-accumulation units. Total coverage is reported for MLChip, which includes code and functional coverage.

The tests evaluate the performance of SRP framework 200 with respect to both RANDOM-SEARCH and GP-BANDIT versus the baseline, which is the human-generated tests with fixed parameters. For black-box optimizer 202, the tests may repurpose the open-source implementations of these algorithms from a hyperparameter tuning platform (e.g., Google Vizier). To mitigate the impact of randomness on the results, the tests ran each experiment five times and reported the average coverage across the five runs.

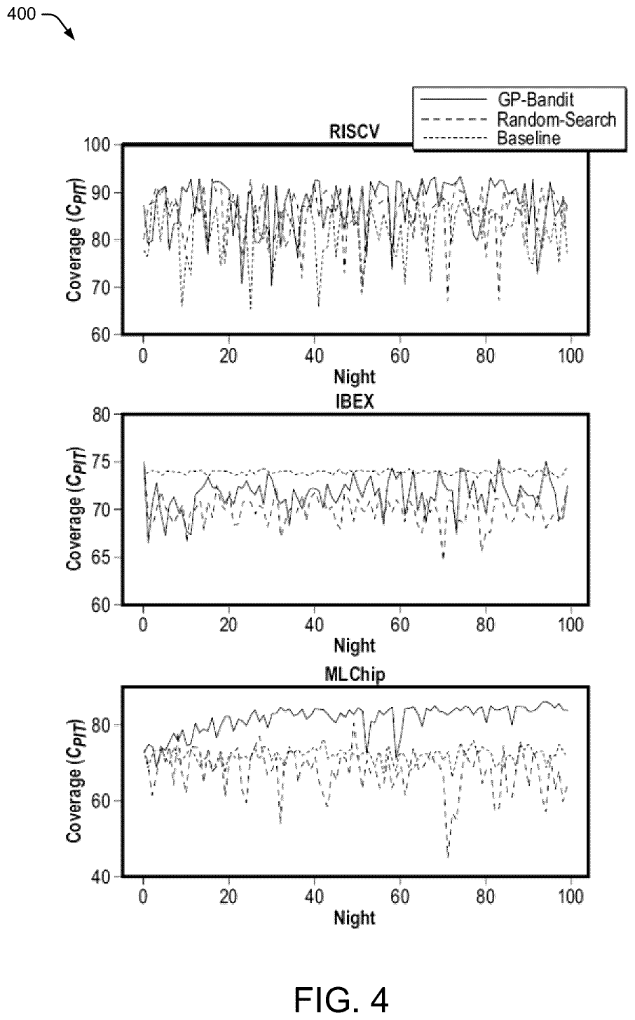

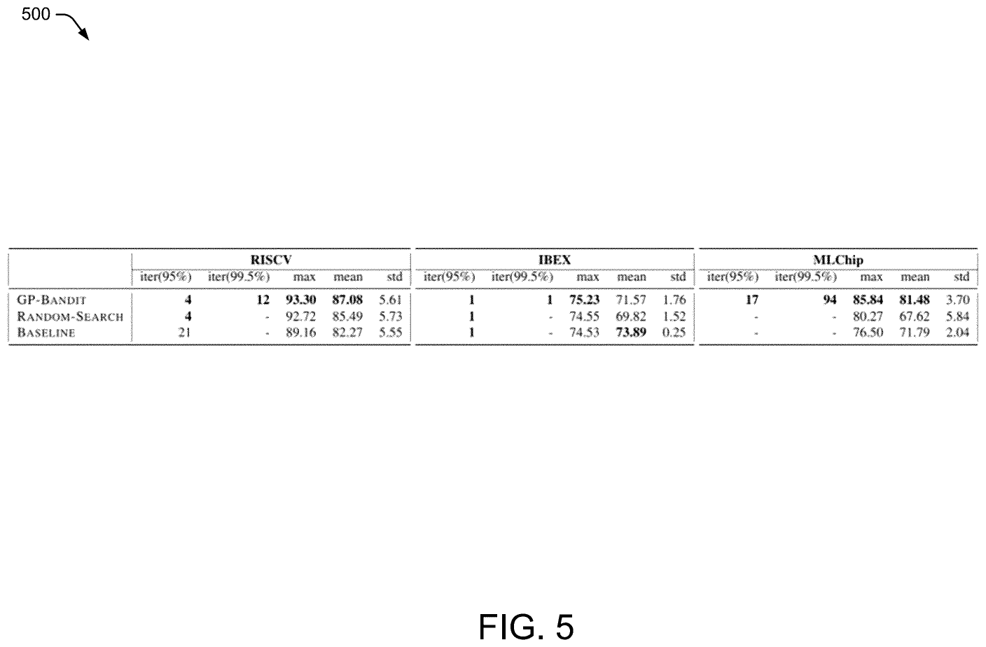

As discussed herein, FIG. 4 illustrates an example point-in-time coverage 400 C_{PIT} over 100 nights, and FIG. 5 illustrates statistics 500 related to point-in-time coverage C_{PIT}. FIG. 5 compares coverage reported by each method when using a random seed (e.g., pseudorandom search) as is part of the state-of-practice standard CRV. In FIG. 5, the notation “—” indicates that the target coverage is not reached within 100 nights. FIG. 5 shows that using SRP framework 200 produces the highest maximum coverage in 100 nights on all designs. The GP-BANDIT performs best, providing up to a 9.34% increase over the baseline and a 5.57% increase over the RANDOM-SEARCH. The GP-BANDIT method in SRP framework 200 converges to the highest coverage points much faster than baseline, resulting in huge time savings during coverage closure. On RISC-V, GP-BANDIT attains 95% of max C_{PIT} in 4 nights while it takes the baseline 21 nights to reach the same coverage. To reach 99.5%, it takes GP-BANDIT 12 nights and more than 100 nights for baseline.

Returning to FIG. 4, each line represents the mean coverage across five random seeds, and the shaded region shows the standard deviation across the five runs. As shown in FIG. 4, when applying GP-BANDIT on MLChip, the figure shows an upward coverage trend increasing over nights leading to the conclusion that the GP-BANDIT is able to learn complex parameter spaces well enough to maximize coverage.

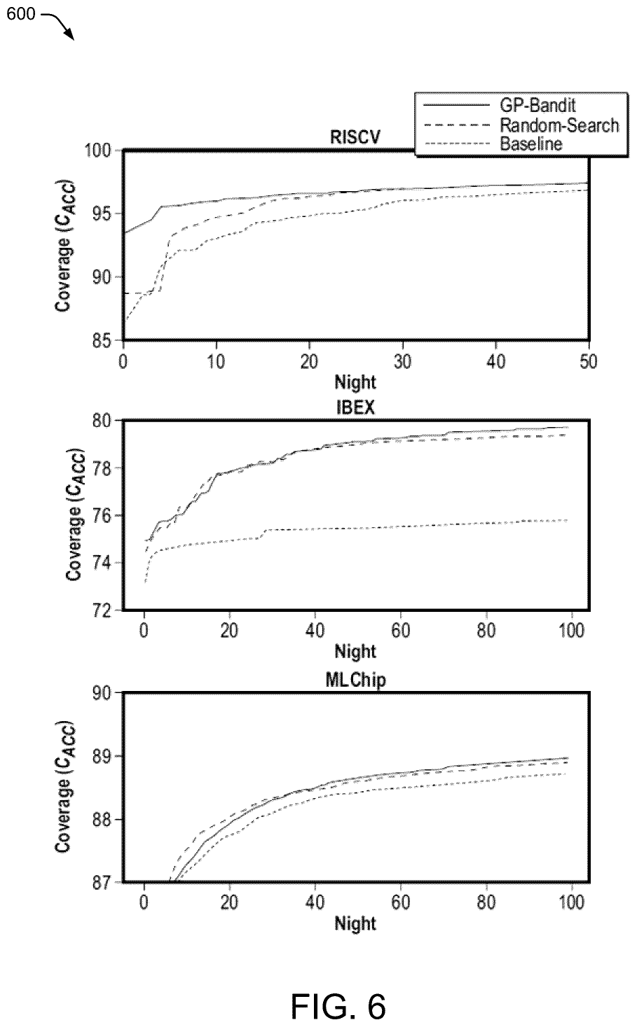

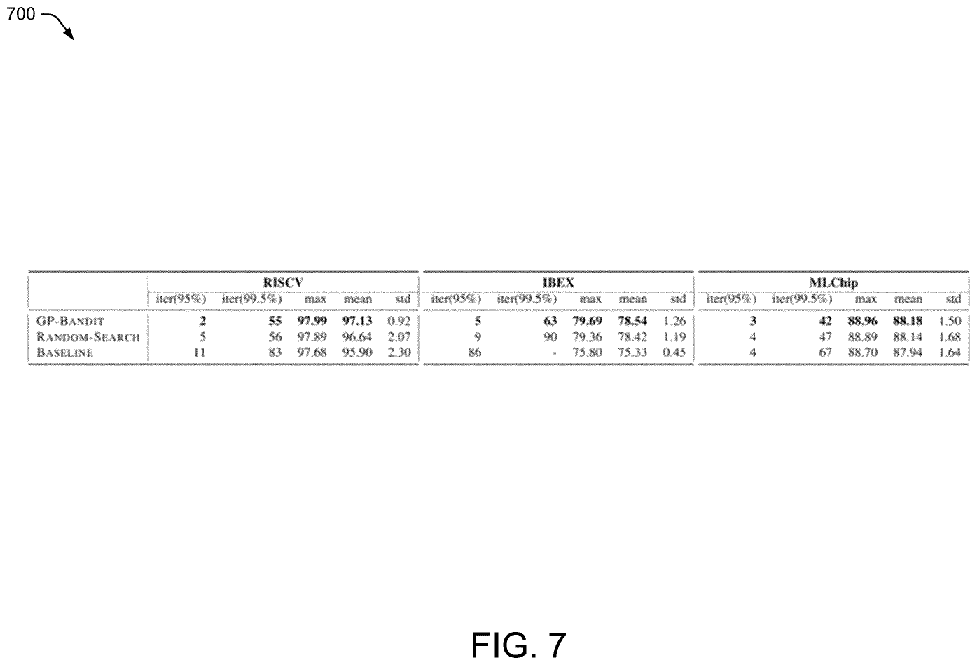

FIG. 6 illustrates an example accumulated coverage 600 C_{ACC} over 100 nights, and FIG. 7 illustrates an example of statistics 700 related to accumulated coverage C_{ACC}. Although C_{ACC} is a metric that the algorithms in SRP framework 200 are not necessarily optimized for, the metric is discussed herein. As shown in FIGS. 6 and 7, SRP framework 200 algorithms achieve a) higher maximum C_{ACC} and b) faster convergence on the last 5% and 0.5% coverage over the baseline on all designs.

For example, on RISC-V, to reach 95% of max C_{ACC}, it takes GP-BANDIT only 2 nights, while it takes RANDOM-SEARCH 5 nights and baseline 11 nights. To reach 99.5% of max C_{ACC}, these numbers grow to 55, 56, and 83 nights, respectively. Like with C_{PIT}, these numbers show the value of the SRP framework 200 process for accumulated coverage during coverage closure.

In some aspects, the SRP framework 200 algorithms might end up with isolated C_{PIT} values that are lower than the human baseline with fixed parameter values. When it is important to ensure that the results do not dip below the human baseline on any given night, the systems and methods propose a new use case for regression testing by running the SRP framework 200 algorithms in addition to the original baseline flow. For example, the systems and methods may merge the coverage for the two runs and report it as the coverage for every iteration. The systems and methods may report the merged coverage of two runs for baseline for a fair comparison.

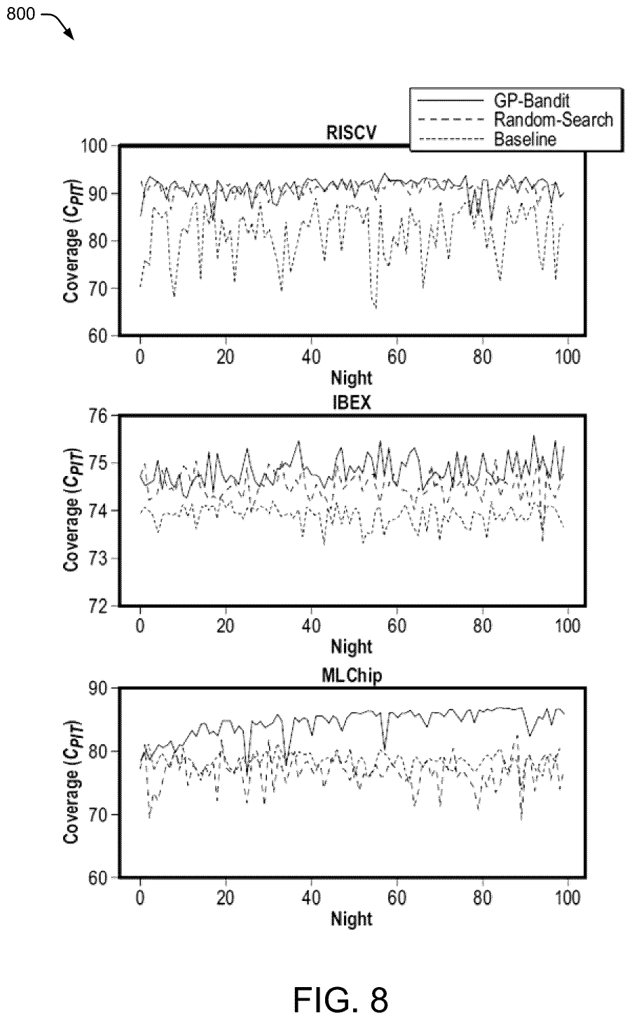

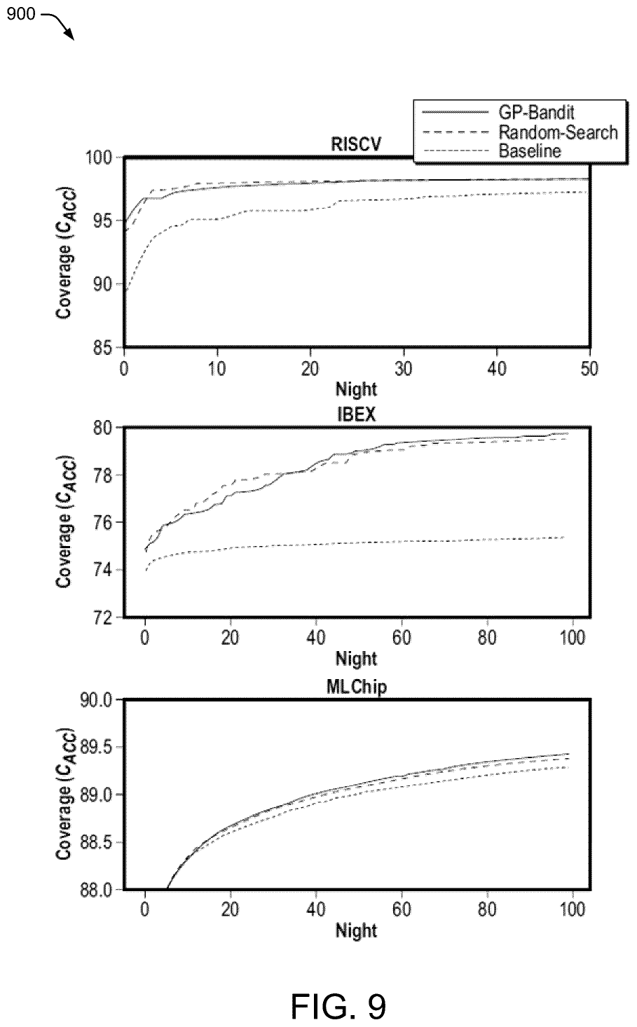

FIG. 8 illustrates an example point-in-time coverage 800 C_{PIT} over 100 nights in addition to the baseline. FIG. 9 illustrates an example accumulated coverage 900 C_{ACC} over 100 nights in addition to baseline.

As shown in FIG. 8, the baseline+SRP mode ensures that C_{PIT} driven by GP-BANDIT+baseline for most nights is higher than the baseline+baseline on all designs. FIG. 9 shows that C_{ACC} may be consistently higher than baseline for every design with GP-BANDIT+baseline. This makes the baseline+SRP mode a highly attractive proposition for practical settings. Note that RANDOM_SEARCH+baseline does not provide any such assurance. Its exploration is quite expansive and frequently falls below the baseline, making it unsuitable as an algorithm for this mode.

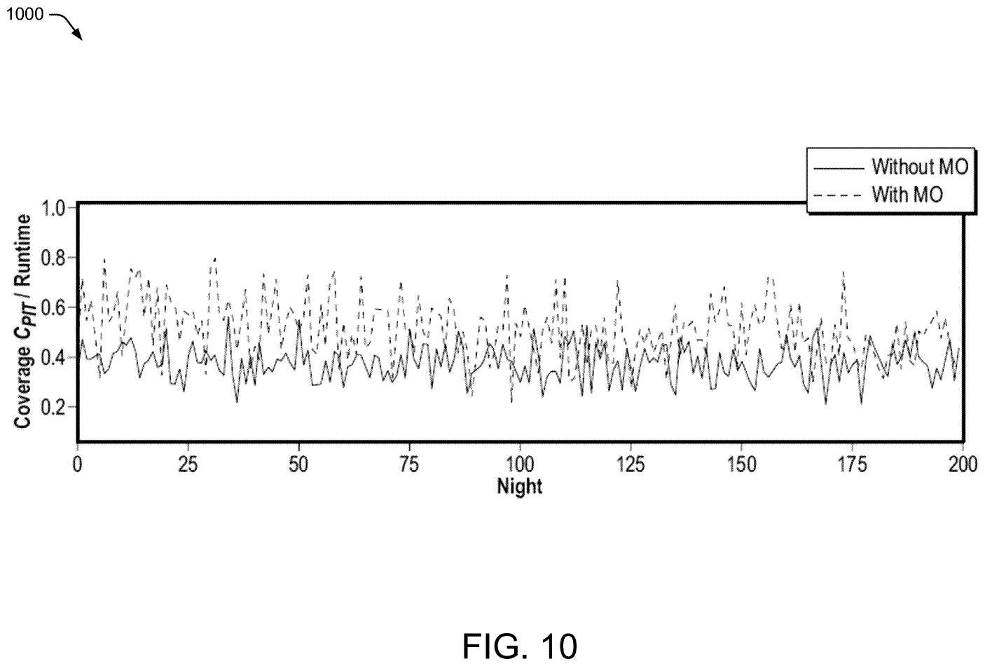

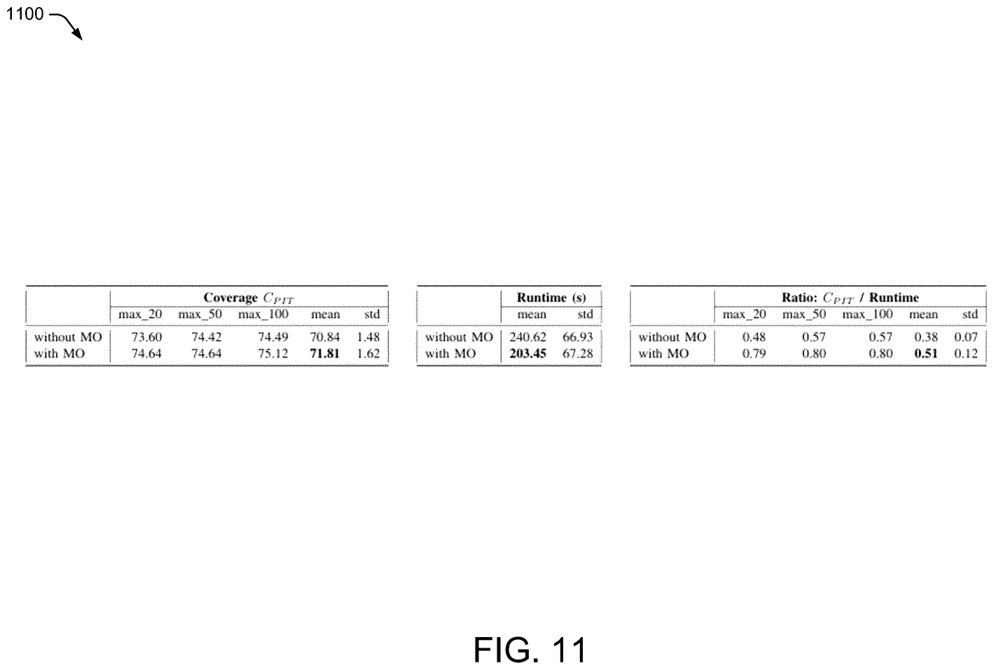

FIG. 10 illustrates an example of a ratio 1000 of point-in-time coverage C_{PIT} over runtime for Ibex with multi-objective optimization (MO). FIG. 11 illustrates an example of statistics 1100 related to point-in-time coverage C_{PIT} and runtime for Ibex with multi-objective optimization.

Optimizing for high coverage can sometimes lead to unacceptably high simulation runtimes. In some situations, a verification engineer might want to trade off one for the other at different points in the verification phase. We explore multi-objective optimization (MO) in Bayesian optimization to simultaneously minimize simulation runtime and maximize coverage. FIG. 11 shows that adding the multi-objective optimization leads to 1.18× speedup in the mean runtime while achieving higher mean coverage over 200 nights. As shown in FIGS. 10 and 11, the mean C_{PIT} over runtime ratio is 34% higher with multi-objective optimization, demonstrating the effective optimization of both objectives.

In some aspects, SRP framework 200 was deployed into real production for the MLChip design (under active development) and ran for 30+ days with the GP-BANDIT algorithm. The systems and methods then collected the unique failure signatures found in the final three days. This bug detection study yielded the following results: 29 signatures were found from 4230 tests (6.86 failures per 1000 tests) driven by GP-BANDIT, while baseline found 26 signatures over 4378 tests (5.94 failures per 1000 tests). Tests that were failing due to infrastructure issues were not counted. Given that each unique signature manifests a bug, this experiment demonstrates not just higher coverage but better bug detection capability with fewer tests.

### Learning in Smart Regression Planner

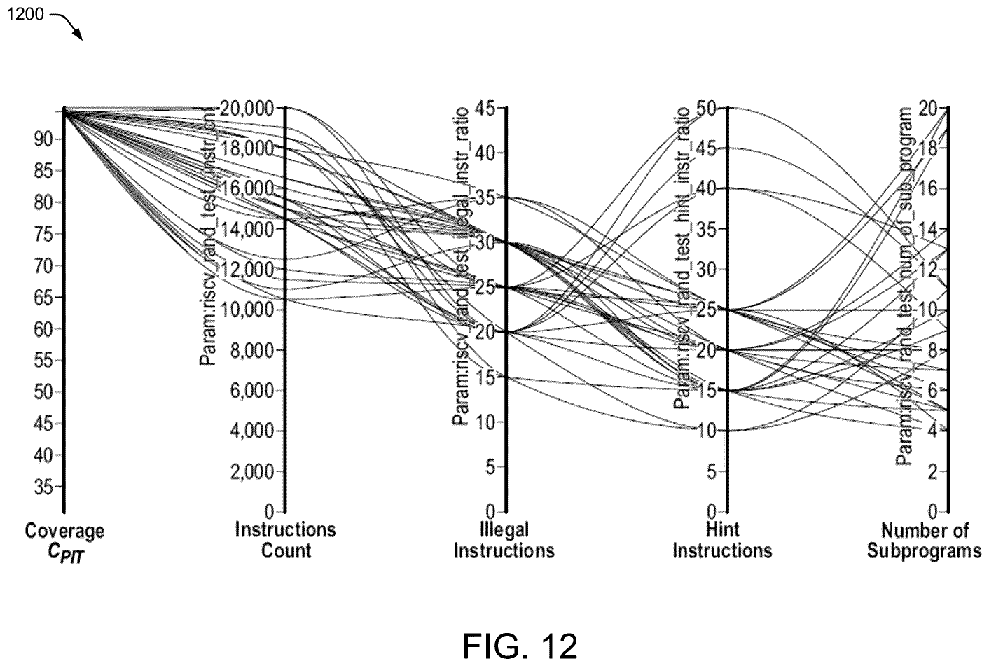

One type of learning is GP-BANDIT-based learning. FIG. 12 illustrates an example of test parameters 1200 suggested by GP-Bandit for 100 iterations or nights. In FIG. 12, each curve represents specific parameter configurations of every test selected by GP-BANDIT. Based on the density of lines across each Y-axis representing the parameter value, it is apparent that the following parameter setup is preferred by GP-BANDIT: test instructions count>10k, 4-20 number of subprograms, 15%-35% of illegal instructions, and 10%-50% of test hint instructions.

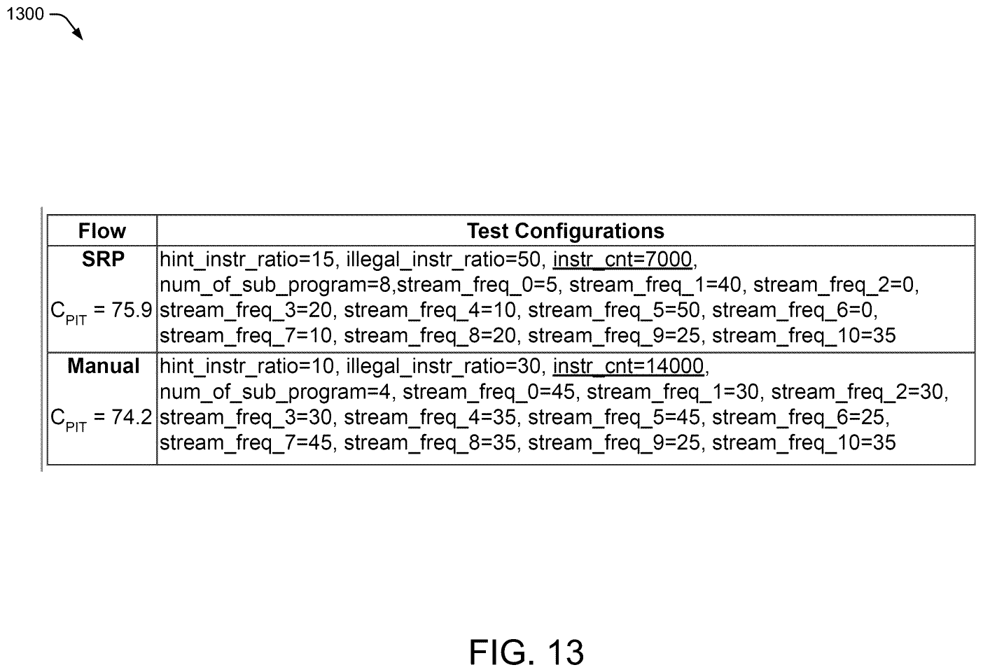

FIG. 13 illustrates an example Smart Regression Planner test 1300 with learned parameters and corresponding manually created baseline test with lower coverage C_{PIT}. The illustration in FIG. 13 shows an example test generated by the SRP approach and the corresponding human-generated baseline test. Some of the parameters like stream frequency of instructions are guessed by humans, but the optimizer settles at a very different value (like stream_freq_2). The SRP test uses fewer instructions, yet it achieves a higher coverage than the human baseline.

Another type of learning is Transfer Learning. An example use case is the addition of new test parameters and design features as the design evolves. Instead of re-training the black-box algorithms in this case, the black-box optimizer may transfer learned heuristics and improve sample efficiency. In the transfer-learning experiments, the test held out 5 of the 11 parameters during initial optimization, then added them back to simulate new parameters being added to the test. This experiment was repeated for 100 random subsets of the parameters to account for the possibility that some parameters may have outsized influence on coverage. In some aspects, transfer learning is performed by performing regressions prior to the first regression. The prior regressions may use all parameters of the first regression or a subset. Transfer learning may include analyzing the results from the previous regression and using the analyzed results to generate test parameters for the first regression. Additionally, the analyzed results may be used in all subsequent regressions.

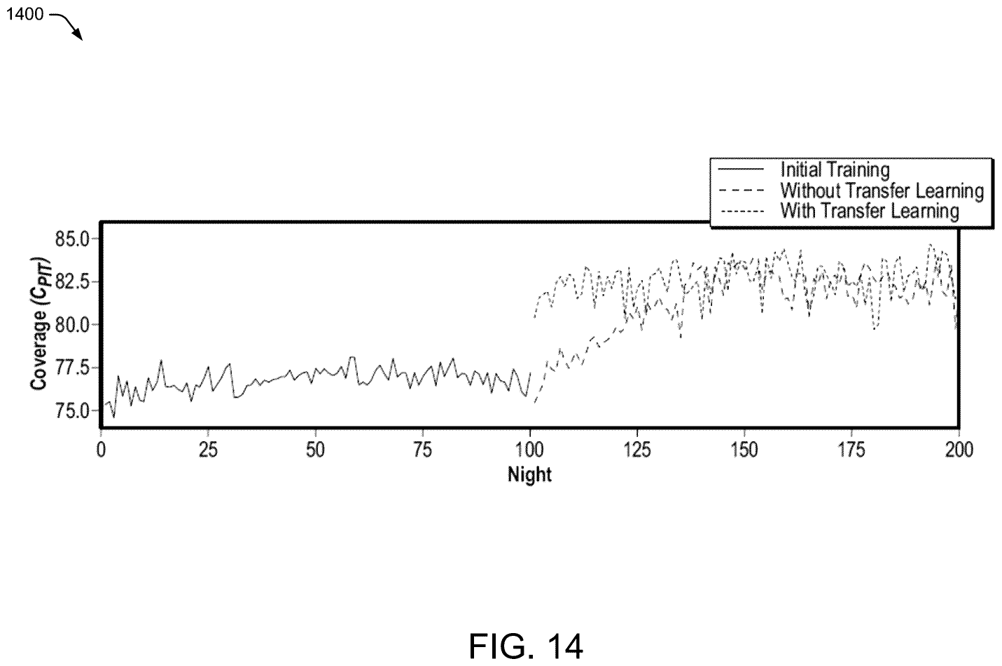

FIG. 14 illustrates an example point-in-time coverage 1400 C_{PIT} over 200 nights. The results of transfer learning in FIG. 14 show that the prior learning from the initial training applies well to new runs with any set of 5 additional test parameters added. The CPIT coverage with transfer learning starts higher and converges about 20 nights earlier compared to the runs without transfer learning, showing the value of this technique. However, the approach did not observe improvement in the accumulated coverage CACC with transfer learning enabled, potentially due to limited exploration.

The tests also included an ablation study with same number of instructions: to make sure the learning is not limited to a trivial parameter like number of instructions, the test fixed the number of instructions in all experiments to the default value and re-ran the experiments with random seeds.

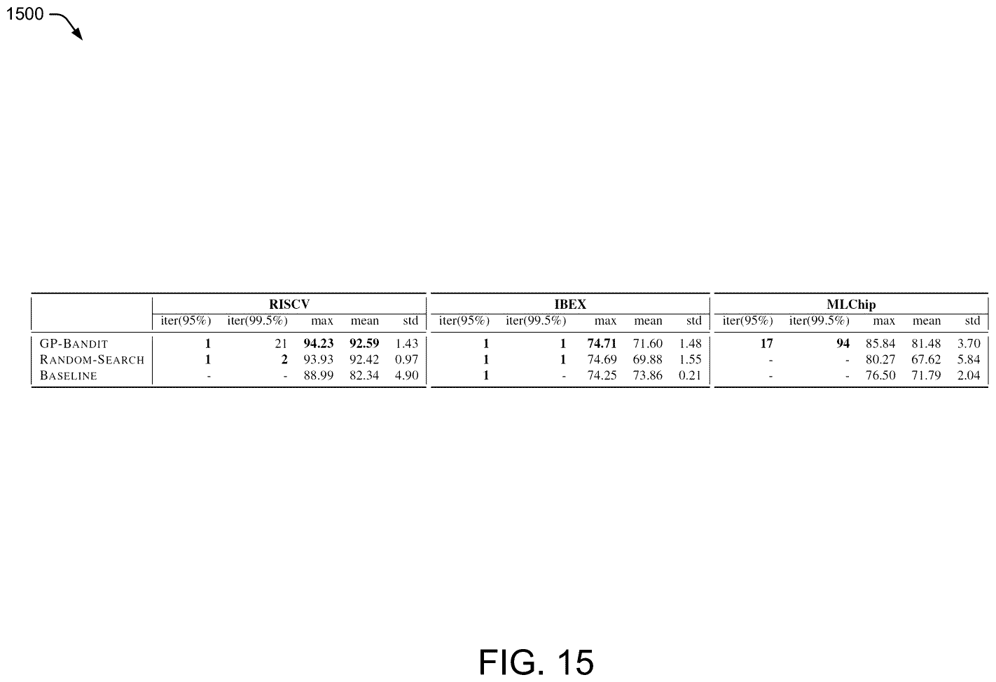

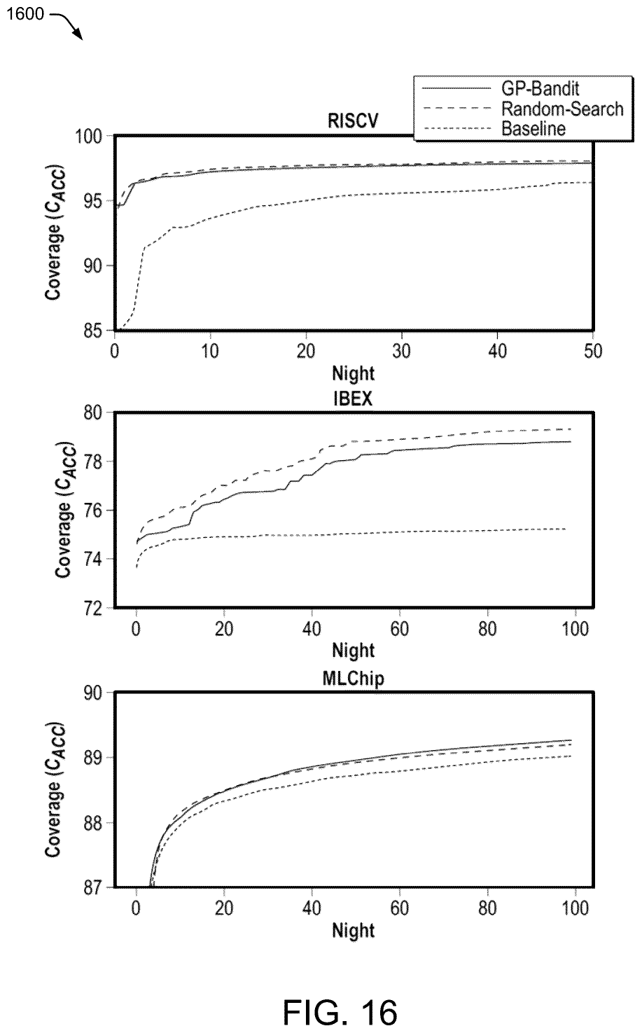

FIG. 15 illustrates an example of statistics 1500 related to point-in-time coverage CPIT for experiments with the same number of instructions. FIG. 16 illustrates an example accumulated coverage 1600 CACC over 100 nights for experiments with the same number of instructions. The results in FIG. 15 are similar to FIG. 5 despite this change. This shows that the GP-BANDIT algorithm has learned enough about the input parameters space to achieve high coverage, even when the trivially correlated parameter is eliminated. Despite using the same number of instructions, CACC from FIG. 16 and CACC from FIG. 6 are very similar.

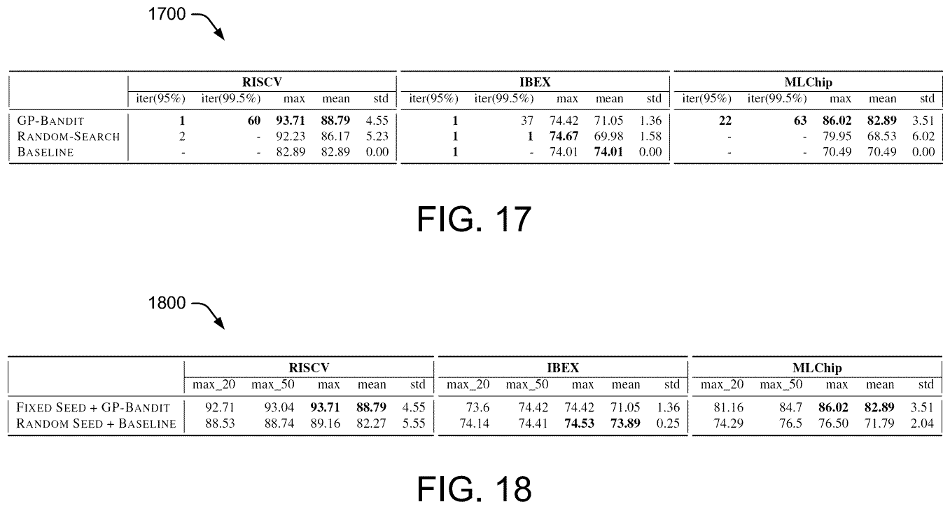

FIG. 17 illustrates an example of statistics 1700 related to point-in-time coverage CPIT with a fixed seed. FIG. 18 illustrates an example of statistics 1800 related to point-in-time coverage CPIT comparison of Fixed Seed+GP-Bandit versus Random Seed+baseline.

In another test, a control experiment was performed with a fixed seed to examine if the learning in SRP proceeds better when the randomness in feedback is eliminated. The test ran 100 nights with the same fixed seed for all algorithms, repeated the experiment 5 times with 5 different seeds, and reported the results shown in FIG. 16. The standard deviation of CPIT across 100 nights of GP-BANDIT is consistently lower than RANDOM-SEARCH on all designs, showing the feedback-based learning in the absence of randomness is more consistent. FIG. 18 illustrates a comparison of the state of practice (RANDOM SEED+baseline) to the SRP flow of GP-BANDIT running with a fixed seed (FIXED SEED+GP-BANDIT). When comparing the maximum CPIT in FIG. 18, FIXED SEED+GP-BANDIT achieves 4.55% higher coverage for RISC-V and 9.52% higher coverage for MLChip. It should be noted that the human baseline for Ibex is already very good, leading to high CPIT and low variance, as shown in FIG. 3.

### Example Method

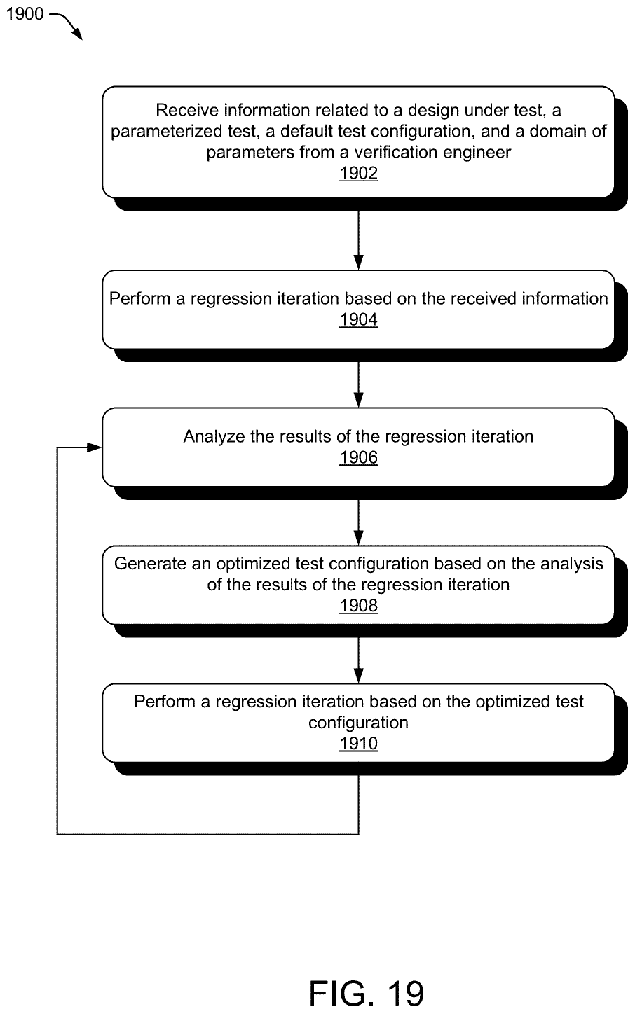

FIG. 19 illustrates an example method 1900 of automatic test parameter tuning. The method 1900 is illustrated as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. The techniques are not limited to performance by one entity or multiple entities operating on one device.

In some aspects, method 1900 is performed by any of the systems discussed herein, such as SRP framework 200. At 1902, a system receives information related to at least one of a design under test, a parameterized test, a default test configuration, or a domain of parameters from a verification engineer. At 1904, the system performs a regression iteration based on the received information. In aspects, the regression iteration utilizes the default test configuration provided by the verification engineer. The results of the regression iteration are analyzed at 1906. For example, a Verilog simulator may be used to determine a point-in-time coverage percentage. At 1908, an optimized test configuration is generated based on the analysis of the results of the regression iteration. For example, the optimized test configuration may include an optimized value determined from the acquisition function for each of the parameters in the parameterized test. At 1910, the system performs a subsequent regression iteration based on the optimized test configuration. In some implementations, the method will begin again at 1906 using the optimized test configuration. For example, the method may continue until total coverage, a coverage threshold, or a predetermined number of iterations is reached.

### Example Computing System

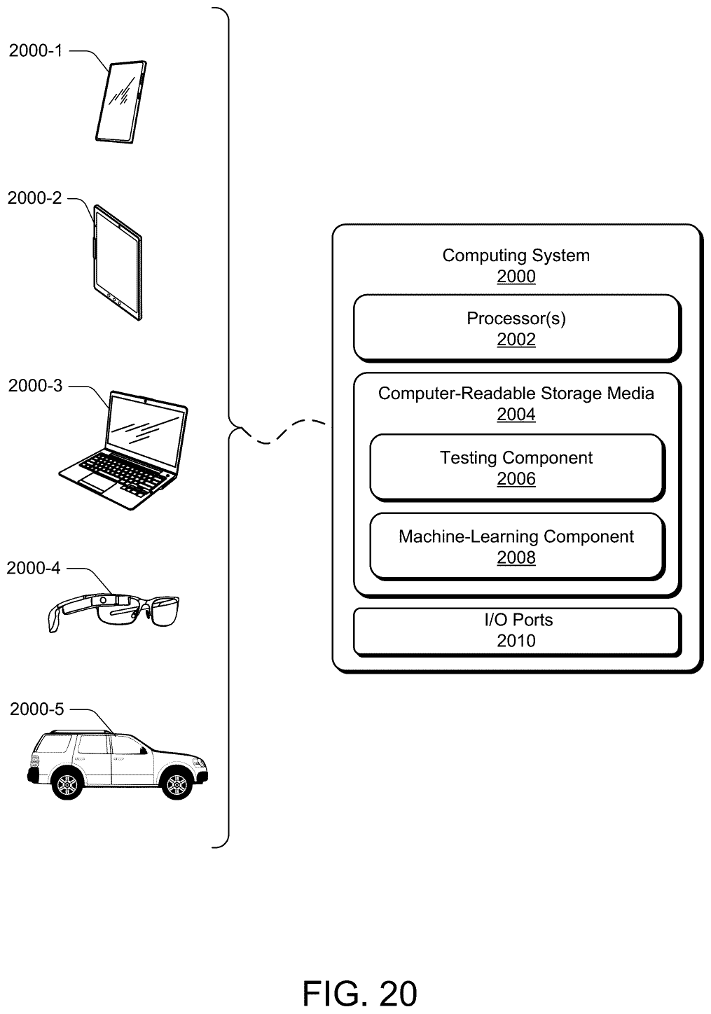

FIG. 20 illustrates various components of an example computing system 2000 that can implement aspects of the disclosed systems and methods. The computing system 2000 can be implemented as any type of client, server, testing system, and/or device as described herein. For example, automatic test parameter tuning may be performed in any computing system 2000 such as a mobile device 2000-1, a tablet 2000-2, a personal computer 2000-3, a wearable computing device 2000-4, or a vehicle 2000-5. Although not shown, other configurations of a computing system are considered such as a desktop, a server, a printer, a digital camera, a gaming console, a home automation terminal, a mobile hotspot and the like. Further, the computing system 2000 may be implemented as a system-on-chip (SoC).

The computing system 2000 includes one or more processors 2002 (e.g., any of microprocessors, microcontrollers, or other controllers) that can process various computer-executable instructions to control the operation of the computing system 2000 and to enable the methods discussed herein. Alternatively, or additionally, the computing system 2000 may be implemented with any one or combination of hardware, firmware, or fixed logic circuitry that is implemented in connection with processing and control circuits. Although not shown, the computing system 2000 may include a system bus or data transfer system that couples the various components within the device. A system bus may include any one or a combination of different bus structures, such as a memory bus or memory controller, a peripheral bus, a universal serial bus, and/or a processor or local bus that utilizes any of a variety of bus architectures.

The computing system 2000 may include any number of computer-readable storage media 2004 (CRM). The computer-readable storage media 2004 may be implemented within the computing system 2000. Alternatively, the computer-readable storage media 2004 may be external but associated with the computing device 2000, for example, stored in a cloud or external hard drive. The computer-readable storage media 2004 may include volatile memory and non-volatile memory, which may include any suitable type, combination, or number of internal or external memory devices. Each memory of the computer-readable storage media 2004 may be implemented as an on-device memory of hardware or an off-device memory that communicates data with the computing system 2000 via a data interface or bus. In one example, volatile memory includes random access memory. Alternatively, or additionally, volatile memory may include other types of memory, such as static random access memory (SRAM), synchronous dynamic random access memory (DRAM), asynchronous DRAM, double-data-rate RAM (DDR), and the like. Further, non-volatile memory may include flash memory or read-only memory (ROM). Other non-volatile memory not shown may include non-volatile RAM (NVRAM), electronically-erasable programmable ROM, embedded multimedia card (eMMC) devices, single-level cell (SLC) flash memory, multi-level cell (MLC) flash memory, and the like.

The computing system 2000 may execute operating systems or applications from any suitable type of computer-readable storage media 2004 including volatile memory and non-volatile memory. Alternatively or additionally, operating systems or applications may be embodied as firmware or any other computer-readable instructions, binaries, or code. The computing system 2000 may include a user interface provided by operating systems or applications to allow specific functionality or services of the computing system 2000.

Computer-readable storage media 2004 may also include a testing component 2006 which may be implemented through machine-readable instructions executable by the processor(s) 2002. The testing component 2006 may include instructions to facilitate the testing operation of the DUT. For example, the testing component 2006 may include a Verilog simulator to analyze the results of the parameterized test of the DUT. Further, the testing component 2006 may be implemented through any combination of hardware, software, or firmware. In aspects, the testing component 2006 is implemented through a hardware description language (HDL). In other implementations, the testing component 2006 may be implemented on the hardware device itself as logic gates, one-time programmable (OTP) memory, fuses, and the like. The computer-readable storage media 2004 may additionally include a machine-learning component 2008 to determine optimized sets of parameters for the nightly regression of the DUT. The machine-learning component 2008 may store previous sets of parameters and the corresponding results of nightly regression using the previous sets of parameters. The machine-learning component 2008 may be configured to provide machine-readable instructions that, when executed by the processor(s) 2002, enable generation of the optimized set of parameters. Additionally, the machine-learning component 2008 may utilize transfer of learned heuristics from previous regression iterations (e.g., conducted prior to the first regression iteration) to better optimize subsequent regression iterations.

The computing system 2000 may also include I/O ports 2010. I/O ports 2010 may allow the computing system to interact with other devices or users. I/O ports 2010 may include any combination of internal or external ports, such as USB ports, audio ports, Serial ATA (SATA) ports, PCI-express based ports or card-slots, secure digital input/output (SDIO) slots, and/or other legacy ports. Various peripherals may be operatively coupled with I/O ports 2010, such as human-input devices (HIDs), external computer-readable storage media, or other peripherals. For example, the I/O ports 2010 may be utilized to receive manually created inputs such as information related to at least one of a design under test, a parameterized test, a default test configuration, or a domain of parameters. In an aspect, the I/O ports 2010 may input or output information through a wired or wireless connection.

Examples of automatic test parameter tuning in constrained random verification is provided below, including those implemented as a computer-readable storage medium or performed by a system containing one or more processor:
Example 1: A computer-implemented method comprising: performing a first regression on a design under test using a first set of parameters, the design under test comprising a logical representation of a hardware system that includes a plurality of logical components for fabrication as an integrated circuit; analyzing results of the first regression including determining a coverage percentage of the first regression; generating, based on the analysis of the results of the first regression, an optimized set of parameters for a subsequent regression; and performing the subsequent regression on the design under test using the optimized set of parameters.
Example 2: The method as recited in example 1, wherein analyzing the results of the first regression includes determining a point-in-time coverage percentage for the first regression.
Example 3: The method as recited by any of the previous examples, wherein analyzing the results of the first regression includes determining an accumulated coverage percentage.
Example 4: The method as recited in any one of examples 1-3, further comprising: repeating the analyzing, generating, and performing steps with the optimized set of parameters for subsequent regressions until total coverage is achieved and storing, for each regression of the first regression and the subsequent regressions, an associated set of parameters and results of each regression to be accessed by future regressions.
Example 5: The method as recited in any one of the previous examples, wherein: the optimized set of parameters comprises at least one hardware condition related to the logical representation of the hardware system of the design under test; or the optimized set of parameters comprises at least one of a bus width, a data width, a register depth, a memory depth, a voltage level, a clock frequency, a timing variable, or a delay useful to optimize the design under test or one of the plurality of logical components of the design under test.
Example 6: The method as recited in any one of the previous examples, wherein generating the optimized parameter set comprises using a black-box optimizer.
Example 7: The method as recited in example 6, wherein generating the optimized parameter set further comprises: selecting, for one or more parameters of the optimized parameter set, a value from a uniformly distributed set of values using a random seed.
Example 8: The method as recited in example 6, wherein generating the optimized parameter set further comprises: generating one or more parameters of the optimized parameter set using a Bayesian optimization algorithm based on: previous parameter sets used to perform previous regressions on the design under test; and analyzed results from the previous regressions using the previous parameter sets.
Example 9: The method as recited in example 6, wherein the Bayesian optimization algorithm comprises: a statistical model used to approximate results of a regression using a specific set of parameters; and an acquisition function used to determine an optimized set of parameters for maximizing results of the regression.
Example 10: The method as recited in example 9, wherein the acquisition function comprises: a mean coverage percentage for a specific value of a parameter based on the analyzed results from previous regressions using previous parameter sets; and an uncertainty coverage percentage for a specific value of a parameter based on an uncertainty of the statistical model using the analyzed results from the previous regressions using the previous parameter sets.
Example 11: The method as recited in example 10 wherein the uncertainty coverage percentage is scaled by a negotiating constant comprising: an exploitation mode corresponding to a smaller negotiating constant; or an exploration mode corresponding to a larger negotiating constant.
Example 12: The method as recited in any one of examples 8-11, wherein the Bayesian optimization algorithm is a Gaussian Process Bandits Bayesian optimization algorithm
Example 13: The method as recited in any one of the previous examples, further comprising: performing, for each regression of the first regression and the subsequent regression, a parallel regression using a predetermined set of parameters.
Example 14: The method as recited in any one of the previous examples, further comprising: prior to performing the first regression: receiving one or more subsets of parameters, each of the one or more subsets of parameters comprising a number of parameters less than or equal to a total number of parameters in the first set of parameters; receiving analyzed results of at least one previous regression using each of the one or more subsets of parameters; and generating the first and any subsequent parameter sets based on at least the analyzed results of each previous regression using each of the one or more subsets of parameters.
Example 15: A method as recited by any of the previous examples, wherein each parameter of the set of parameters has a predetermined domain.
Example 16: A method as recited by any of the previous examples, wherein the design under test is a hardware device. For example, the design under test may be a design of a central processing unit (CPU), machine learning processor, memory, cache controller, or other processing device.
Example 17: A method as recited in any of previous examples 1 to 16, wherein the design under test is an algorithm or software application.
Example 18: A method as recited in any of previous examples, further comprising modifying the design under test as a result of a regression.
Example 19: A method as recited in any previous example, further comprising making the design under test. For example, the method may comprise implementing and/or fabricating (i.e. manufacturing) an article according to the design under test.
Example 20: The method as recited in any of the previous examples, wherein: the optimized set of parameters comprises at least one hardware condition related to the logical representation of the hardware system of the design under test.
Example 21: A computer-readable storage medium comprising computer-readable instructions that, when executed by one or more processors, perform the method of any one of examples 1-20.
Example 22: A system comprising: one or more processors; and a computer-readable storage medium comprising computer-readable instructions that, when executed by the one or more processors, perform the method of any one of examples 1-20.

### CONCLUSION

Although aspects of the described systems and methods for implementing automatic test parameter tuning in constrained random verification have been described in language specific to features and/or methods, the subject of the appended claims is not necessarily limited to the specific features or methods described. Rather, the specific features and methods are disclosed as example implementations of automatic test parameter tuning in constrained random verification, and other equivalent features and methods are intended to be within the scope of the appended claims. Further, various aspects of automatic test parameter tuning in constrained random verification are described, and it is to be appreciated that each described aspect can be implemented independently or in connection with one or more other described aspects.

1. A method comprising:
performing a first regression on a design under test using a first set of parameters, the design under test comprising a logical representation of a hardware system that includes a plurality of logical components for fabrication as an integrated circuit;
analyzing results of the first regression including determining a coverage percentage of the first regression;
generating, based on the analysis of the results of the first regression, an optimized set of parameters for a subsequent regression; and
performing the subsequent regression on the design under test using the optimized set of parameters.

2. The method as recited in claim 1, wherein analyzing the results of the first regression includes determining a point-in-time coverage percentage for the first regression.

3. The method as recited in claim 1, further comprising:
repeating the analyzing, generating, and performing steps with the optimized set of parameters for subsequent regressions until total coverage is achieved; and
storing, for each regression of the first regression and the subsequent regressions, an associated set of parameters and results of each regression to be accessed by future regressions.

4. The method as recited in claim 1, wherein:
the optimized set of parameters comprises at least one hardware condition related to the logical representation of the hardware system of the design under test; or
the optimized set of parameters comprises at least one of a bus width, a data width, a register depth, a memory depth, a voltage level, a clock frequency, a timing variable, or a delay useful to optimize the design under test or one of the plurality of logical components of the design under test.

5. The method as recited in claim 1, wherein generating the optimized parameter set comprises using a black-box optimizer.

6. The method as recited in claim 5, wherein generating the optimized parameter set further comprises:
selecting, for one or more parameters of the optimized parameter set, a value from a uniformly distributed set of values using a random seed.

7. The method as recited in claim 5, wherein generating the optimized parameter set further comprises:
generating one or more parameters of the optimized parameter set using a Bayesian optimization algorithm based on:
previous parameter sets used to perform previous regressions on the design under test; and
analyzed results from the previous regressions using the previous parameter sets.

8. The method as recited in claim 7, wherein the Bayesian optimization algorithm comprises:
a statistical model used to approximate results of a regression using a specific set of parameters; and
an acquisition function used to determine an optimized set of parameters for maximizing results of the regression.

9. The method as recited in claim 8, wherein the acquisition function comprises:
a mean coverage percentage for a specific value of a parameter based on the analyzed results from the previous regressions using the previous parameter sets; and
an uncertainty coverage percentage for a specific value of a parameter based on an uncertainty of the statistical model using the analyzed results from the previous regressions using the previous parameter sets.

10. The method as recited in claim 9, wherein the uncertainty coverage percentage is scaled by a negotiating constant comprising:
an exploitation mode corresponding to a smaller negotiating constant; or
an exploration mode corresponding to a larger negotiating constant.

11. The method as recited in claim 7, wherein the Bayesian optimization algorithm is a Gaussian Process Bandits Bayesian optimization algorithm.

12. The method as recited in claim 1, further comprising:
performing, for each regression of the first regression and the subsequent regression, a parallel regression using a predetermined set of parameters.

13. The method as recited in claim 1, further comprising:
prior to performing the first regression:
receiving one or more subsets of parameters, each of the one or more subsets of parameters comprising a number of parameters less than or equal to a total number of parameters in the first set of parameters;
receiving analyzed results of at least one previous regression using each of the one or more subsets of parameters; and
generating the first and any subsequent parameter sets based on at least the analyzed results of each previous regression using each of the one or more subsets of parameters.

14. (canceled)

15. (canceled)

16. The method as recited in claim 1, wherein analyzing the results of the first regression includes determining an accumulated coverage percentage.

17. The method as recited in claim 1, wherein each parameter of the optimized set of parameters has a predetermined domain.

18. The method as recited in claim 1, wherein the design under test is a hardware device, the hardware device selected from the group consisting of:
a processing unit, the processing unit including a machine-learning processor;
memory; or
a cache controller.

19. The method as recited in claim 1, wherein the design under test is an algorithm or software application.

20. The method as recited in claim 1, further comprising:
modifying the design under test as a result of the first regression, the subsequent regression, or another regression.

21. The method as recited in claim 1, further comprising:
manufacturing an article according to the design under test.

22. The method as recited in claim 1, wherein the optimized set of parameters comprises at least one hardware condition related to the logical representation of the hardware system of the design under test.
